(19) United States
(12) Patent Application Publication
(10) Pub. No.: US 2008/0236144 A1
(43) Pub. Date: Oct. 2, 2008

(54) CONTROL SYSTEM OF INTERNAL COMBUSTION ENGINE AND METHOD FOR CONTROLLING THE SAME

(75) Inventors: Shingo Nakata, Kariya-city (JP); Tomoaki Nakano, Toyota-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/036,454

(22) Filed: Feb. 25, 2008

(30) Foreign Application Priority Data
Mar. 28, 2007 (JP) 2007-85555

(51) Int. Cl. F02B 75/10; F02D 21/08; F02D 41/06; F02D 43/00; F02P 5/04

(52) U.S. Cl. 60/284; 60/300; 701/113; 60/285

(57) ABSTRACT

An internal combustion engine has an exhaust passage provided with a catalyst to purify exhaust gas. A control system for the internal combustion engine performs a quick-warming control to accelerate warming up of the catalyst when a predetermined condition is satisfied after the internal combustion engine begins cold startup. The control system further performs an advance control to advance an ignition timing further than an idling-ignition timing at the time of an idling operation in a period between beginning of the cold startup of the internal combustion engine and a time point where the quick-warming control is started.

### CROSS REFERENCE TO RELATED APPLICATIONS

This application is based on and incorporates herein by reference Japanese Patent Application No. 2007-85555 filed on Mar. 28, 2007.

### FIELD OF THE INVENTION

The present invention relates to a control system of an internal combustion engine having a catalyst for purifying exhaust gas emitted from the internal combustion engine. The present invention further relates to a method for controlling the internal combustion engine.

### BACKGROUND OF THE INVENTION

In recent years, a vehicle mounted with an internal combustion engine has a catalyst such as a three-way catalyst for purifying exhaust gas of the internal combustion engine. However, such a catalyst is low in exhaust gas purification rate until the catalyst is warmed up to an active temperature after a cold startup of the internal combustion engine. Accordingly, the vehicle conducts a catalyst quick-warming-up control to warm up the catalyst to active temperature after cold startup of the internal combustion engine, thereby warming up the catalyst in a short time.

For example, U.S. Pat. No. 6,732,504 B2 (JP-B2-3858622) proposes a catalyst quick-warming-up control that retards an ignition timing to increase temperature of exhaust gas exhausted from an internal combustion engine to accelerate increasing of the temperature of the catalyst,

Further, U.S. Pat. No. 5,974,792 (JP-A-9-88564) proposes a dither control of an air-fuel ratio. The dither control alternately changes an air-fuel ratio between a high ratio and a low ratio during the catalyst quick-warming-up control. Specifically, the internal combustion engine alternately emits rich gas having a high concentration of hydrocarbon (HC) and carbon oxide (CO) and lean gas having a high concentration of oxygen (O₂). The rich gas is mixed with the lean gas in the catalyst to develop an oxidation reaction of rich components. Thus, the catalyst is efficiently warmed up from the inside by generating reaction heat.

Alternatively JP-A-2006-220020 proposes a combination of increasing of an exhaust gas temperature and a dither control. Specifically, a first-step warming-up control is conducted to increase exhaust gas temperature by retarding an ignition timing after cold startup to bring a catalyst into a half warmed-up state. In the half warmed-up state, the catalyst is warmed up to temperature at which the catalyst causes an oxidation reaction of rich components. Thereafter, a dither control as a second-step warming-up control is conducted to develop oxidation reaction of rich components in the catalyst to thereby bring the catalyst into a completely warmed-up state by generating reaction heat.

Each of the catalyst quick-warming-up controls described in the above patent documents shortens the time required to warm up the catalyst to reduce the quantity of emission of HC before finishing the warming-up of the catalyst. However, each of the catalyst quick-warming-up controls is not performed from the beginning of the cold startup. Specifically, the above catalyst quick-warming-up control is not performed until a predetermined condition for performing the catalyst quick-warming-up control is satisfied after the cold startup. At the time of the cold startup, the air-fuel ratio of air-fuel mixture is controlled on the rich side to enhance combustion stability so as to ensure startability of the engine and drivability of the vehicle. In this condition, it is impossible to effectively restrict a large quantity of HC from being emitted before the catalyst quick-warming-up control is performed. Accordingly, the quantity of emission of HC cannot be sufficiently reduced at the time of the cold startup.

### SUMMARY OF THE INVENTION

In view of the foregoing and other problems, it is an object of the present invention to produce a control system for an internal combustion engine that can reduce emission of hydrocarbon at the time of cold startup of the internal combustion engine. It is another object of the present invention to produce a method for controlling the internal combustion engine.

According to one aspect of the present invention, a control system for an internal combustion engine having an exhaust passage provided with a catalyst to purify exhaust gas, the control system comprises quick-warming control means for performing a quick-warming control to accelerate warming up of the catalyst when a predetermined condition is satisfied after the internal combustion engine begins cold startup. The control system further comprises ignition timing control means for performing an advance control to advance an ignition timing further than an idling-ignition timing at the time of an idling operation in a period between beginning of the cold startup of the internal combustion engine and a time point where the quick-warming control is started.

According to another aspect of the present invention, a method for controlling an internal combustion engine having an exhaust passage provided with a catalyst to purify exhaust gas, the method comprises performing cold startup of the internal combustion engine. The method further comprises performing an advance control to advance an ignition timing further than an idling-ignition timing at the time of an idling operation after the beginning of the cold startup. The method further comprises performing a quick-warming control to accelerate warming up of the catalyst when a predetermined condition to terminate the advance control is satisfied.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing an engine control system in a first embodiment of the present invention;

FIG. 2 is a graph showing a relationship between an air-fuel ratio and a concentration of lower hydrocarbon;

FIG. 3 is a graph showing the relationship between an ignition timing and the concentration of lower hydrocarbon;

FIG. 4 is an enlarged sectional view showing a cell structure of a hydrocarbon adsorption catalyst formed in the shape of hexagonal cells;

FIG. 5 is a graph showing an example of a temperature characteristic of the hydrocarbon adsorption catalyst;

FIG. 6 is a graph showing an example of a hydrocarbon emission characteristic at the time of cold startup;

FIG. 7 is a flowchart showing a control for reducing emission of hydrocarbon at the time of cold startup in the first embodiment;

FIG. 8 is a flowchart showing a control for reducing emission of hydrocarbon at the time of cold startup in the second embodiment;

FIG. 9 is a flowchart showing a control for reducing emission of hydrocarbon at the time of cold startup in the third embodiment; and

FIG. 10 is a flowchart showing a control for reducing emission of hydrocarbon at the time of cold startup in the fourth embodiment.

### DETAILED DESCRIPTION OF PREFERRED EMBODIMENTS

### First Embodiment

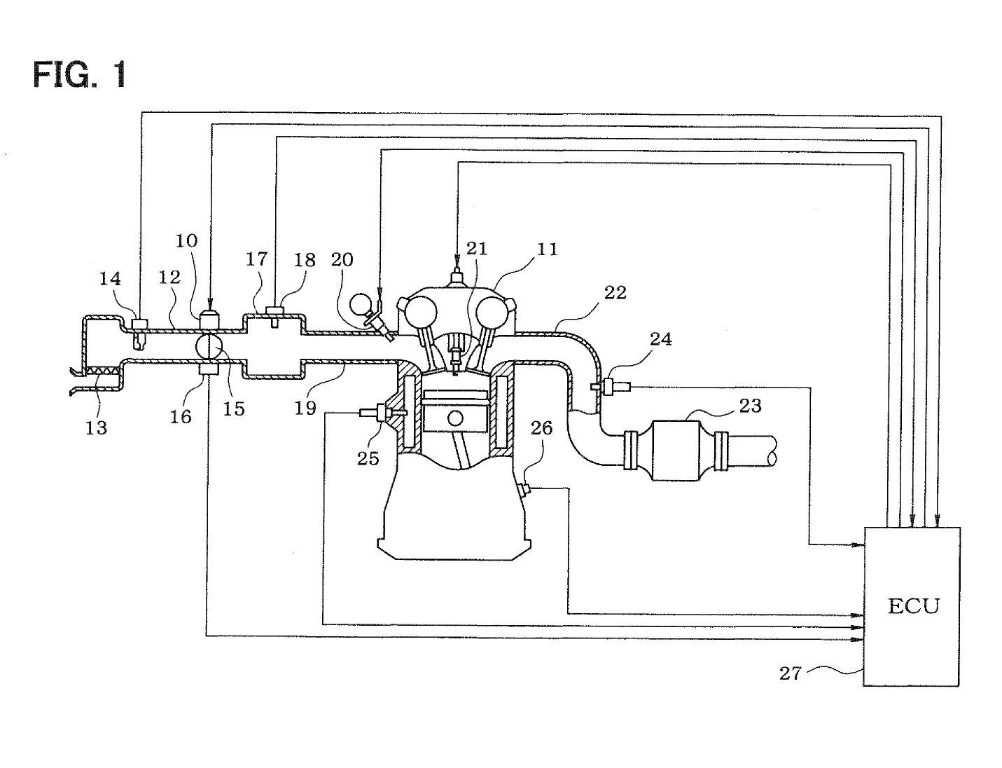

A first embodiment will be described with reference to FIGS. 1 to 7. First, a general construction of an engine control system will be described with reference to FIG. 1. An air cleaner 13 is provided at the uppermost stream of an intake pipe 12 of an internal combustion engine 11. An air flowmeter 14 for detecting an intake air quantity is provided downstream of the air cleaner 13. A throttle valve 15 controlled by a motor 10 and a throttle opening sensor 16 for detecting a throttle opening are provided downstream of the air flowmeter 14.

Further, a surge tank 17 is provided downstream of the throttle valve 15. An intake pipe pressure sensor 18 for detecting an intake pipe pressure is provided in the surge tank 17. The surge tank 17 is equipped with an intake manifold 19 for introducing air into cylinders of the engine 11. Fuel injection valves 20 for injecting fuel are respectively provided near the intake ports of the intake manifold 19 of the respective cylinders. Further, ignition plugs 21 are fixed to a cylinder head of the engine 11 for the respective cylinders. Air-fuel mixture in each cylinder is ignited by the spark discharge of each ignition plug 21.

Still further, the cylinder block of the engine 11 is mounted with a water temperature sensor 25 for detecting temperature of cooling water of the engine 11. The cylinder block of the engine 11 is mounted with a crank angle sensor 26 (engine speed determination means) for outputting a pulse signal every time the crankshaft of the engine 11 revolves a predetermined crank angle such as 30°CA. The crank angle and the engine rotation speed are detected on the basis of the output signal of the crank angle sensor 26.

The outputs of the various sensors are inputted to an engine control unit (ECU) 27. The ECU 27 as a control means is mainly constructed of a microcomputer. The ECU 27 executes various engine control programs stored in a built-in ROM (storage medium) to control a fuel injection quantity and the ignition timing of the ignition plug 21 according to an engine operating state.

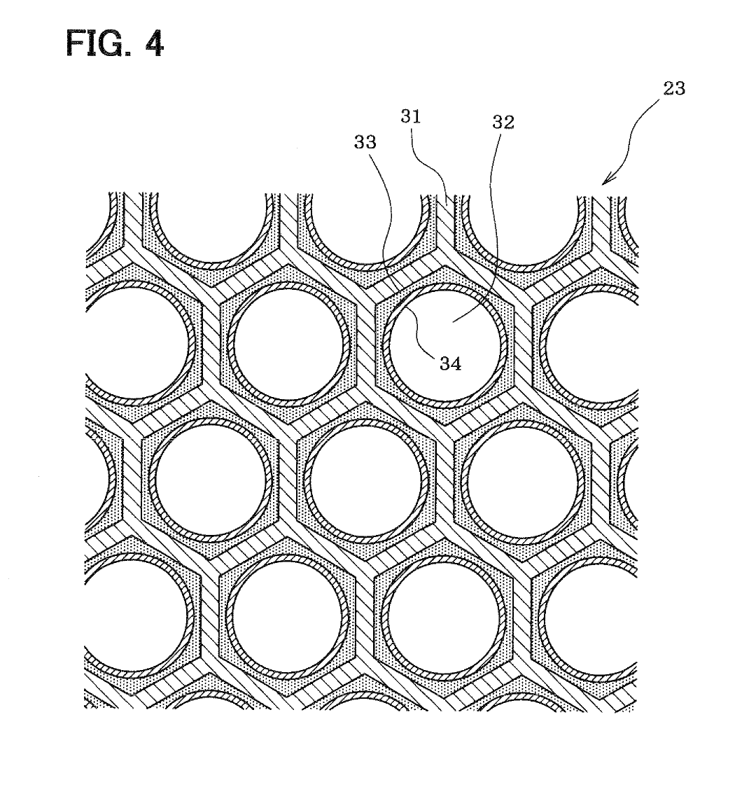

On the other hand, an exhaust pipe (exhaust passage) 22 of the engine 11 is provided with a hydrocarbon adsorption catalyst 23 and an air-fuel ratio sensor (air-fuel ratio determination means) 24. The air-fuel ratio sensor 24 for detecting the air-fuel ratio of exhaust gas is provided upstream of the catalyst 23. As shown in FIG. 4, the hydrocarbon adsorption catalyst 23 is constructed of a hexagonal cell base material 31 formed of a ceramic material such as cordierite. The hexagonal cell base material 31 is a monolithic support in the shape of a hexagonal honeycomb. The inner peripheral surface of each cell 32 is coated with a hydrocarbon adsorption material layer 33, which is of a mesh structure having a large number of fine pores and is made of zeolite. The surface of this hydrocarbon adsorption material layer 33 is coated with a catalyst component layer 34 made of noble metal such as platinum and rhodium.

In the hydrocarbon adsorption catalyst 23 constructed of the hexagonal cell base material 31, partition walls between the cells 32 are uniform in thickness, and exhaust gas flows through the cells 32. Thus, the hydrocarbon adsorption catalyst 23 has an advantage that the hydrocarbon adsorption catalyst 23 can secure mechanical strength and can efficiently secure passage sectional areas of the respective cells 32. In addition, each of the cells 32 is formed in a shape close to a circle. Therefore, the hydrocarbon adsorption catalyst 23 has also an advantage that the hydrocarbon adsorption material layers 33 and the catalyst component layers 34, which are formed on the inner peripheral surfaces of the cells 32, are reduced in variations in thickness as compared with a square cell structure. Hence, the hydrocarbon adsorption catalyst 23 can enhance an adsorbing capacity and an oxidizing capacity of hydrocarbon at a small quantity of coating and a small heat capacity.

Further, in the present first embodiment, the hydrocarbon adsorption catalyst 23 formed in the shape of a hexagonal cell is constructed so as to be reduced in the total weight of both the cell base material 31 and the adsorption material layer 33 per unit surface area as compared with a hydrocarbon adsorption catalyst formed in the shape of a square cell. The hydrocarbon adsorption catalyst 23 formed in the shape of the hexagonal cell can reduce a heat capacity required to secure the same hydrocarbon adsorption capacity as the hydrocarbon adsorption catalyst formed in the shape of a square cell as compared with the hydrocarbon adsorption catalyst formed in the shape of a square cell. Hence, by reducing the heat capacity of the hydrocarbon adsorption catalyst 23, a period required to warm up the hydrocarbon adsorption catalyst 23 can be shortened.

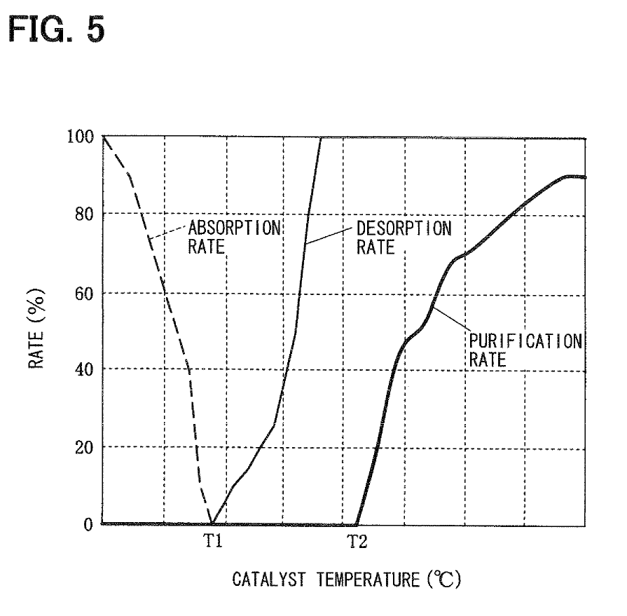

As shown in FIG. 5, in a low temperature range immediately after cold startup, temperature (catalyst temperature) of the hydrocarbon adsorption material layer 33 is in the range lower than a predetermined temperature TI. According to the temperature characteristic of the hydrocarbon adsorption catalyst 23 in FIG. 5, hydrocarbon is only adsorbed in the range lower than the predetermined temperature T1. As the catalyst temperature increases, a rate (hydrocarbon adsorption rate) of hydrocarbon adsorption decreases in the range lower than the predetermined temperature T1.

In the range where the catalyst temperature is greater than the predetermined temperature T1, hydrocarbon is not adsorbed, but hydrocarbon starts to be desorbed instead. As the catalyst temperature further increases, a rate (desorption rate) of desorption of hydrocarbon rapidly increases. Further, in the range where the catalyst temperature is greater than a predetermined temperature T2, the catalyst component layer 34 starts to be activated to purify hydrocarbon. As the catalyst temperature increases further, the catalyst component layer 34 is further activated to increase a rate (purification rate) of purification of hydrocarbon.

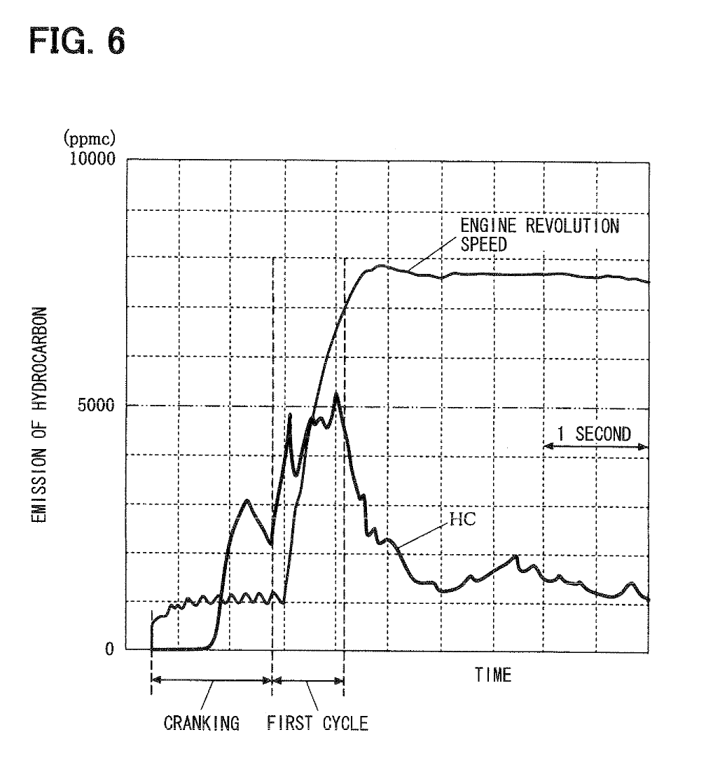

As shown in FIG. 6, at the time of cold startup of the engine 11, cracking is started to begin injection and ignition of fuel. In the present condition, hydrocarbon emitted from the engine 11 rapidly increases and the quantity of emission of hydrocarbon is at the maximum in starting of one cycle of the cranking. Thereafter, as a combustion state stabilizes, the quantity of emission of hydrocarbon decreases. Thus, to reduce the quantity of emission of hydrocarbon at the time of cold startup, it is necessary to reduce the quantity of emission of hydrocarbon in a period between starting of the cranking and the time point immediately after completion of the cold startup. The quantity of emission of hydrocarbon decreases immediately after the completion of the cold startup.

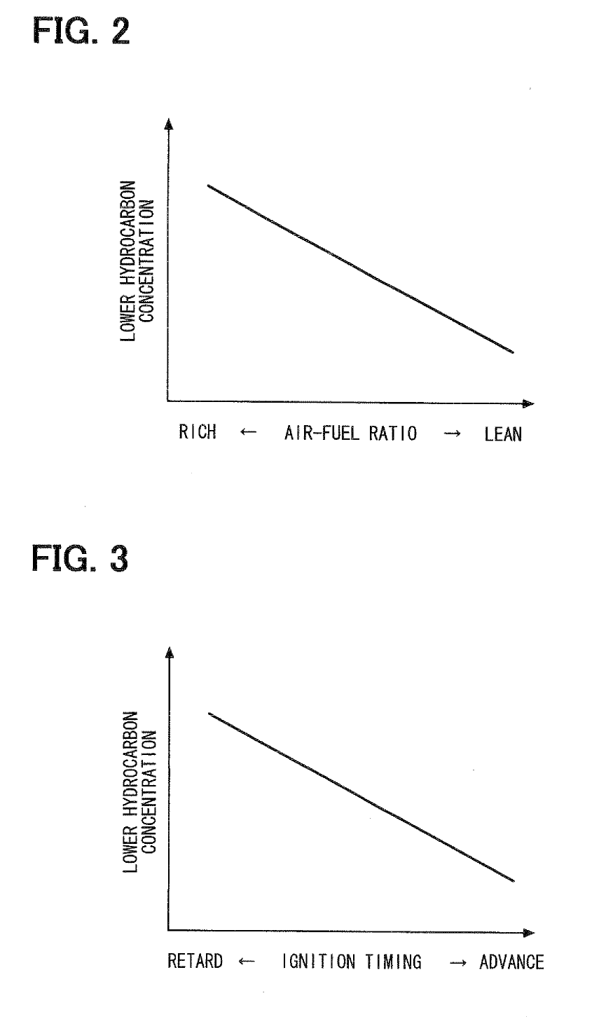

The following results are obtained by experiment and research of the inventor. First, as shown in FIG. 2, as the air-fuel ratio of an air-fuel mixture moves to the rich side, hydrocarbon emitted at the time of cold startup becomes higher in the rate of lower hydrocarbon. That is, as the air-fuel mixture becomes richer, a concentration (lower hydrocarbon concentration) of lower hydrocarbon becomes higher in the emission of exhaust gas. The lower hydrocarbon is a mixture of hydrogen and carbon and has a small number of carbons. Second, as shown in FIG. 3, as an ignition timing advances, the lower hydrocarbon concentration becomes lower in the exhaust gas. At the time of cold startup, the air-fuel ratio of the air-fuel mixture is controlled on the rich side such that the air-fuel mixture becomes rich so as to secure startability of combustion in the engine 11 and drivability of the vehicle. Referring to FIG. 2, hydrocarbon emitted from the engine 11 during the present rich air-fuel ratio period increases in the rate of lower hydrocarbon. Thus, when the ignition timing is advanced during the present rich air-fuel period to reduce the concentration of lower hydrocarbon in the exhaust gas, the quantity of emission of hydrocarbon at the time of cold startup can be further reduced.

The hydrocarbon adsorption material layer 33 forms a zeolite layer of a mesh structure having a large number of fine pores. The hydrocarbon adsorption material layer 33 coated with the hydrocarbon adsorption catalyst 23 has a specific hydrocarbon adsorption characteristic. Specifically higher hydrocarbons having a larger number of carbons are easily trapped by fine pores and hence adsorbed. However, hydrocarbons having a small number of carbons passing through the fine pores are less easily adsorbed. Thus, the lower hydrocarbon emitted from the engine 11 during the rich air-fuel ratio period at the time of cold startup is less easily adsorbed by the hydrocarbon adsorption catalyst 23. Hence, to reduce the quantity of emission of hydrocarbon at the time of cold startup, the quantity of emission of lower hydrocarbon during the rich air-fuel ratio period needs to be reduced.

Referring to FIG. 3, in the present first embodiment, attention is paid to the characteristic that as the ignition timing further advances, the concentration of lower hydrocarbon in the exhaust gas becomes less. Therefore, the following control is performed. First, an ignition timing advance control for reducing lower hydrocarbon in the exhaust gas, which is less easily adsorbed by the hydrocarbon adsorption catalyst 23, is performed at the time of cold startup of the engine 11 or in a period during which the air-fuel ratio is controlled at high in a rich state after the cranking is started. Second, a catalyst quick warming-up control is started at the timing when the air-fuel ratio becomes lower than a threshold to satisfy a predetermined condition for performing the catalyst quick warming-up control. In the catalyst quick warming-up control, the air-fuel ratio is controlled at a slightly lean ratio and to control the ignition timing to a retard side to thereby quickly warm up the hydrocarbon adsorption catalyst 23.

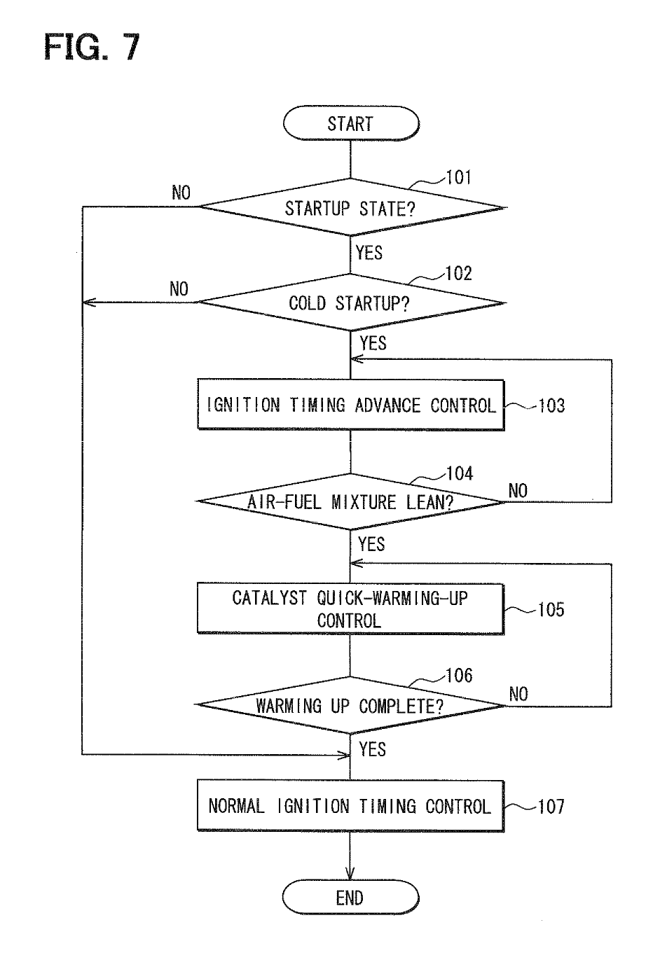

In the first embodiment, the control for reducing the quantity of emission of hydrocarbon at the time of cold startup is performed by the ECU 27 in the following manner according to a control program shown in FIG. 7. The control program in FIG. 7 as ignition timing control means and quick-warming control means is performed at predetermined intervals in a period during which the ignition switch is ON and the power of the ECU 27 is turned ON. When the present program is started, first, it is determined in step 101 whether the engine 11 is in a startup state. When it is determined that the engine 11 is not in the startup state, the routine proceeds to step 107 where a normal ignition timing control is performed. The normal ignition timing control is an ignition timing control performed after finishing a quick-warming control of the catalyst 23.

When it is determined in step 101 that the engine 11 is in the startup state, the routine proceeds to step 102 where it is determined whether the engine 11 is in cold startup on the basis oft for example, cooling water temperature detected by the water temperature sensor 25. When it is determined that the engine 11 is not in cold startup, the routine proceeds to step 107 where the normal ignition timing control is performed.

In contrast, when it is determined in step 102 that the engine 11 is in cold startup, the routine proceeds to step 103. In step 103, the ignition timing advance control is performed from the beginning of cranking, and the ignition timing advance control advances the ignition timing with respect to the ignition timing (idling-ignition timing) at the time of an idling operation, thereby the concentration of lower hydrocarbon in the exhaust gas is reduced. At this time, to simplify the ignition timing advance control, the ignition timing in the ignition timing advance control may be fixed to a certain ignition timing. Alternatively, the ignition timing of the ignition timing advance control may be manipulated according to the richness of the air-fuel ratio, i.e., the richness of the air-fuel mixture. In this manner, the correction of advance in the ignition timing can be controlled adaptively in response to the correction of advance in the ignition timing required to reduce the concentration of lower hydrocarbon to a predetermined concentration or less according to the richness of the air-fuel ratio.

Moreover, as the quantity of exhaust gas recirculation (EGR) of the engine 11 increases and the rate of residual exhaust gas increases, the combustion speed of the air-fuel mixture becomes slower. Therefore, the quantity of EGR may be estimated by the ECU 27 at the time of cold startup, so that the ignition timing in the ignition timing advance control may be manipulated according to the quantity of EGR. In this manner, the correction of advance in the ignition timing can be manipulated in response to the fact that the combustion speed is manipulated according to the quantity of EGR, whereby startability (combustion stability) and drivability of the vehicle in the cold startup can be enhanced.

It is preferable that the ignition timing in the ignition timing advance control is advanced within a range not exceeding an optimal ignition timing. That is, it is preferable that the advance in the ignition timing is limited to within the range of the optimal ignition timing. This is because when the ignition timing advances beyond the optimal ignition timing, fuel consumption may increase and knocking may occur.

While the ignition timing advance control is performed, it is determined in step 104 whether the air-fuel ratio detected by the air-fuel ratio sensor 24 is leaner than a threshold i.e. the air-fuel mixture is leaner than a predetermined condition. The ignition timing advance control is continuously performed until it is determined that the air-fuel ratio detected by the air-fuel ratio sensor 24 is leaner than the threshold, i.e., air-fuel mixture is leaner than the predetermined condition. In this manner, the ignition timing advance control is performed in a period in which air-fuel mixture is rich after the cranking is started.

Thereafter, when it is determined that air-fuel mixture is leaner than the predetermined condition according to the air-fuel ratio detected by the air-fuel ratio sensor 24, the ignition timing advance control is terminated. In the present condition, it is determined that the condition for performing the catalyst quick-warming-up control is satisfied, so that the routine proceeds to step 105 where the catalyst quick-warming-up control is started. In this catalyst quick-warming-up control, the ignition timing is controlled to the retard side, and the air-fuel ratio is controlled such that air-fuel mixture is slightly leaner. In this manner, the temperature of the exhaust gas is increased by retarding the ignition timing during the catalyst quick-warming-up control. Thereby, increasing of temperature of the hydrocarbon adsorption catalyst 23 is accelerated, and at the same time hydrocarbon in the exhaust gas is reduced and the concentration of lean components such as oxygen in the exhaust gas is increased by controlling the air-fuel ratio such that the air-fuel mixture becomes slightly leaner. In this manner, the oxidation reaction of hydrocarbon in the hydrocarbon adsorption catalyst 23 can be accelerated, and hence the quantity of emission of hydrocarbon during the catalyst quick-warming-up control can be efficiently reduced.

During the catalyst quick-warming-up control, in step 106, the temperature of the hydrocarbon adsorption catalyst 23 is estimated or detected, and it is determined whether the hydrocarbon adsorption catalyst 23 is brought to a warm-up state where warming up of the hydrocarbon adsorption catalyst 23 is substantially completed. When it is determined that the hydrocarbon adsorption catalyst 23 is brought to the warm-up state, the catalyst quick-warming-up control is terminated. Thereafter, the routine proceeds to step 107 where the normal ignition timing control is performed. Here, the method for estimating the temperature of the hydrocarbon adsorption catalyst 23 will be described in the third embodiment to be described later.

In the present first embodiment, the ignition timing advance control is performed for advancing the ignition timing to reduce lower hydrocarbon in the exhaust gas in a period during which the air-fuel mixture is richer than the predetermined condition after the cranking is started at the time of cold startup. Thereafter, when the air-fuel mixture becomes leaner than the predetermined condition, the catalyst quick-warming-up control is started. Thus, the air-fuel ratio of the air-fuel mixture is controlled such that the air-fuel mixture becomes rich so as to secure startability (combustion stability) and drivability at the time of cold startup. In the present operation, increase in lower hydrocarbon caused by controlling the air-fuel ratio to enrich the air-fuel mixture can be suppressed by the ignition timing advance control. Hence, it is possible to achieve both the securing of the startability and the drivability and a reduction in the quantity of emission of hydrocarbon at the time of cold startup.

### Second Embodiment

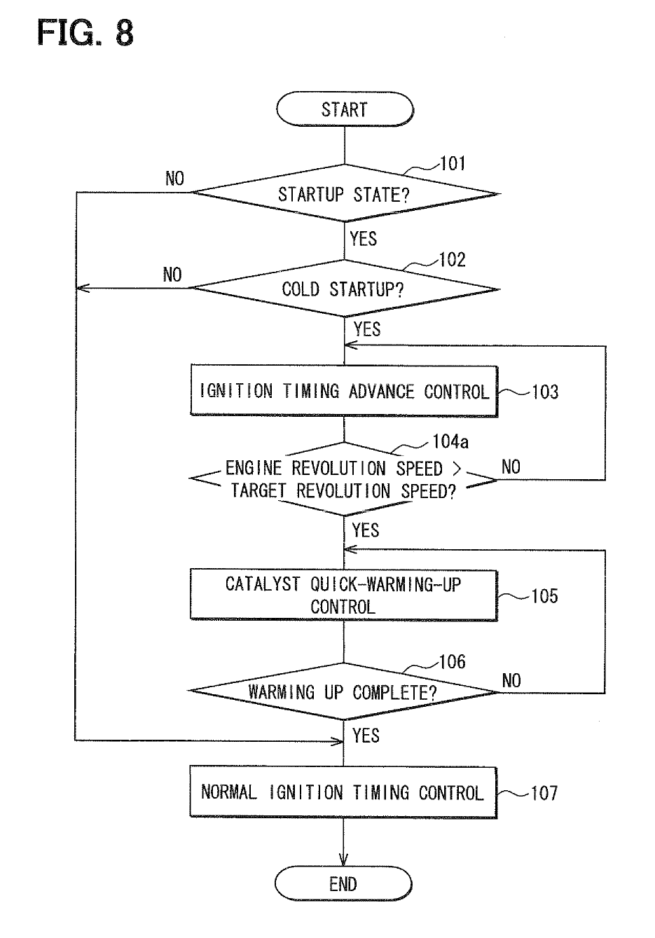

In the second embodiment, a control program shown in FIG. 8 is performed for reducing the quantity of emission of hydrocarbon at the time of cold startup. In the control program in FIG. 8, only the processing in step 104 of the control program in FIG. 7 in the first embodiment is changed to step 1 04a, and the processings in the other steps are substantially the same.

In the control program in FIG. 8, in steps 101 to 103, the ignition timing advance control is performed for advancing the ignition timing so as to reduce lower hydrocarbon in the exhaust gas from the beginning of cranking at the time of cold startup similarly to the first embodiment. While the ignition timing advance control is performed, it is determined in step 104a whether the engine revolution speed becomes greater than target revolution speed, at which the engine can secure stability in revolution. The ignition timing advance control is continuously performed until the engine revolution speed becomes greater than the target revolution speed. Thereafter, the ignition timing advance control is terminated in response to the engine revolution speed becoming greater than the target revolution speed. In the present condition, the routine proceeds to step 105 where the catalyst quick-warming-up control is performed.

In the present second embodiment, the air-fuel ratio of the air-fuel mixture is controlled to enrich the air-fuel mixture to secure startability in a period between the beginning of the cold startup and the time point where the engine revolution speed is increased to the target revolution speed, at which the engine can secure revolution stability (startability). In the present operation, increase in lower hydrocarbon caused by controlling the air-fuel ratio to enrich the air-fuel mixture can be suppressed by the ignition timing advance control. In addition, the catalyst quick-warming-up control can be started earlier than in the case of the first embodiment. In this manner, the period between the beginning of the cold startup and the time point where the warming-up of the hydrocarbon adsorption catalyst 23 is terminated can be shortened, and hence the quantity of emission of hydrocarbon at the time of cold startup can be reduced.

### Third Embodiment

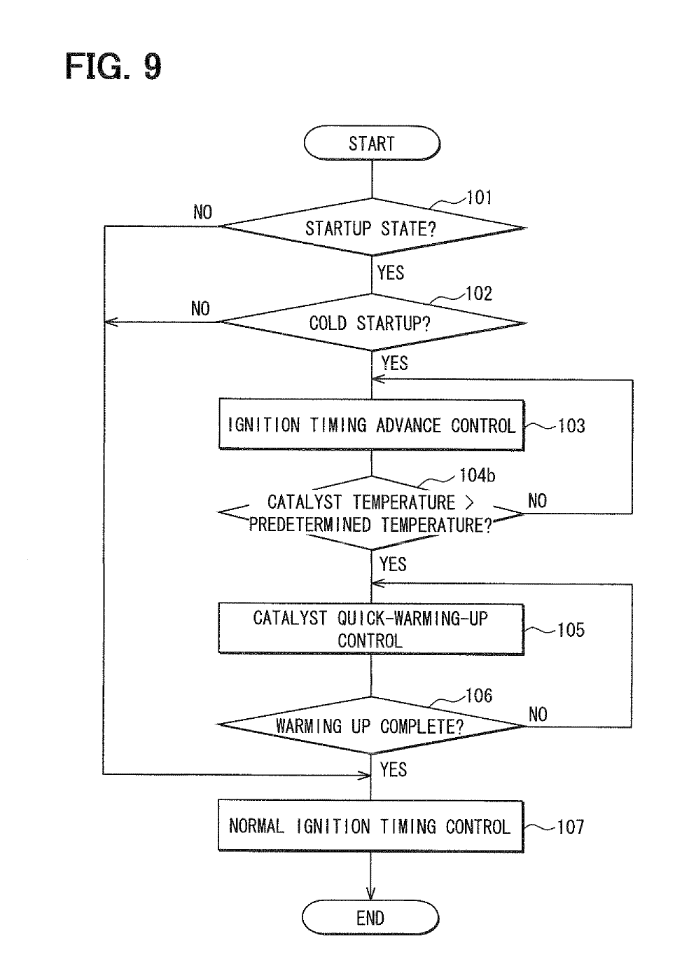

In the third embodiment, a control program shown in FIG. 9 is performed for reducing the quantity of emission of hydrocarbon at the time of cold startup. In the control program in FIG. 9, only the processing in step 104 of the control program in FIG. 7 in the first embodiment is changed to step 104b, and the processings of the other steps are the same.

In the control program in FIG. 9, in steps 101 to 103, the ignition timing advance control is performed for advancing the ignition timing so as to reduce lower hydrocarbon in the exhaust gas from the beginning of cranking at the time of cold startup similarly to the first embodiment. While the ignition timing advance control is performed, it is determined in step 104b whether the catalyst temperature becomes greater than predetermined temperature. In step 104b, the predetermined temperature is, for example, first temperature, at which hydrocarbon starts to be desorbed, or second temperature, at which hydrocarbon can be purified, or third temperature lower than the first and second temperatures. At this time, the catalyst temperature may be estimated by any method. For example, an increase in the catalyst temperature after starting of the engine can be estimated on the basis of a cumulative amount of exhaust heat after the engine is started. Thereafter, the increase in the catalyst temperature after starting of the engine can be added to the catalyst temperature at the time of starting of the engine to estimate the catalyst temperature T at the present time.

$$Catalyst temperature = increase in catalyst temperature after starting of the engine + ( catalyst temperature at the time of starting of the engine ) = K \times ( c umulative amount of exhaust heat after starting of the engine ) + ( catalyst temperature at the time of starting of the engine ) = K \times \int ( exhaust temperature \times exhaust flow rate ) d t + ( catalyst temperature at the time of starting of the engine )$$

In the present formula, K is a coefficient for computing increase in the catalyst temperature T caused by exhaust heat. The exhaust heat or exhaust temperature may be measured by an exhaust temperature sensor provided upstream of the hydrocarbon adsorption catalyst 23 in the exhaust pipe 22. Alternatively, the exhaust heat or exhaust temperature may be estimated from the engine operating conditions. It suffices to estimate the exhaust flow rate from the suction air flow rate detected by the air flowmeter 14.

Here, the increase in the catalyst temperature after starting of the engine may be estimated on the basis of any one of the cumulative amount of fuel injection quantity after starting of the engine, an integrated suction air quantity after starting of the engine, and a period after starting of the engine, in place of the cumulative amount of exhaust heat after starting of the engine. Moreover, the catalyst temperature at the time of starting of the engine may be estimated from the cooling water temperature at the time of starting of the engine, the cooling water temperature being detected by the water temperature sensor 25. Alternatively, the catalyst temperature at the time of starting of the engine may be estimated in consideration of an engine stop period and an outside air temperature in addition to the cooling water temperature. Further, the catalyst temperature may be estimated on the basis of the exhaust gas temperature detected by the exhaust temperature sensor provided downstream of the hydrocarbon adsorption catalyst 23. The catalyst temperature may be measured by the temperature sensor provided in the hydrocarbon adsorption catalyst 23.

In the present third embodiment, the ignition timing advance control is continuously performed until the catalyst temperature becomes greater than the predetermined temperature. The ignition timing advance control is terminated when the catalyst temperature becomes greater than the predetermined temperature. Thereafter, the routine proceeds to step 105 where the catalyst quick-warming-up control is performed.

In the third embodiment described above, the air-fuel ratio of the air-fuel mixture can be controlled to enrich the air-fuel mixture in the specific period between the beginning of the cold startup and the time point where the temperature of the hydrocarbon adsorption catalyst 23 is increased to the predetermined temperature. Thus, startability and drivability can be secured. In addition, increase in lower hydrocarbon caused by enrichment of air-fuel mixture can be suppressed by the ignition timing advance control to reduce the quantity of emission of hydrocarbon at the time of cold startup.

### Fourth Embodiment

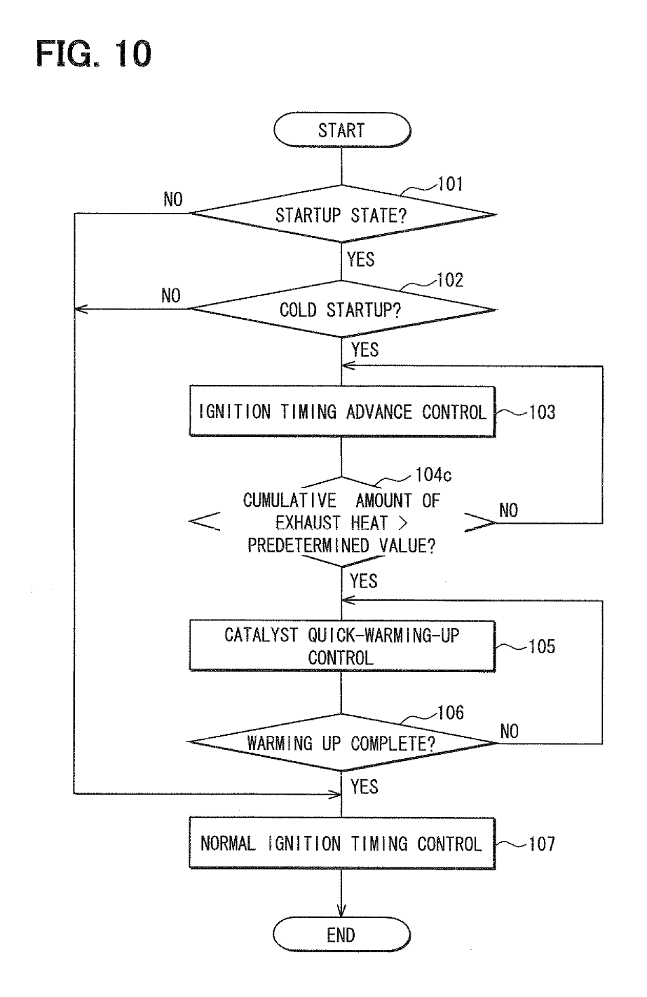

In the fourth embodiment, a control program shown in FIG. 10 is performed for reducing the quantity of emission of hydrocarbon at the time of cold startup.

In the control program in FIG. 10, only the processing in step 104 of the control program in FIG. 7 in the first embodiment is changed to step 104c, and the processings of the other steps are the same.

In the control program in FIG. 10, in steps 101 to 103, the ignition timing advance control is performed for advancing the ignition timing so as to reduce lower hydrocarbon in the exhaust gas from the beginning of cranking at the time of cold startup similarly to the first embodiment. While the ignition timing advance control is performed, it is determined in step 104c whether the cumulative amount of exhaust heat after starting of the engine becomes greater than a predetermined value. Here, the cumulative amount of exhaust heat after starting of the engine is data used as catalyst temperature information relating to the temperature of the catalyst. Here, any one of the cumulative amount of fuel injection quantity after starting of the engine, the integrated suction air quantity after starting of the engine, and the period after starting of the engine may be used as the catalyst temperature information in place of the cumulative amount of exhaust heat after starting of the engine.

In the present fourth embodiment, the ignition timing advance control is continuously performed until the cumulative amount of fuel injection quantity after starting of the engine becomes greater than the predetermined temperature. In addition, the ignition timing advance control is terminated when the cumulative amount of the fuel injection quantity after starting of the engine becomes greater than the predetermined value. Thereafter, the routine proceeds to step 105 where the catalyst quick-warming-up control is performed.

Also in the present fourth embodiment described above, the same effect as in the third embodiment can be produced.

Here, while the hydrocarbon adsorption catalyst 23 formed in the shape of a hexagonal cell has been used in the respective first to fourth embodiments, a hydrocarbon adsorption catalyst formed in another shape such as a square cell may be used. Further, the catalyst is not limited to the hydrocarbon adsorption catalyst. The above operation may be applied also to an exhaust gas purifying system provided with any one of a three-way catalyst, an oxidation catalyst, and a NOx adsorber catalyst.

In addition, the catalyst quick-warming-up control may be performed by any other method, for example, any one or a combination of any two or more of a dither control, an ignition timing retard control, a lean control, a control of increasing of the revolution speed of the internal combustion engine, and a control of introducing secondary air into the exhaust passage to develop after burning (oxidation reaction) of rich components.

The air-fuel ratio of exhaust gas may be determined in accordance with an operating condition of the engine or the like. The engine speed may be determined in accordance with an operating condition of the engine or the like.

The above processings such as calculations and determinations are not limited being executed by the ECU 27. The control unit may have various structures including the ECU 27 shown as an example.

The above structures and operations of the embodiments can be combined as appropriate.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A control system for an internal combustion engine having an exhaust passage provided with a catalyst to purify exhaust gas, the control system comprising:
quick-warming control means for performing a quick-warming control to accelerate warming up of the catalyst when a predetermined condition is satisfied after the internal combustion engine begins cold startup; and
ignition timing control means for performing an advance control to advance an ignition timing further than an idling-ignition timing at the time of an idling operation in a period between beginning of the cold startup of the internal combustion engine and a time point where the quick-warming control is started.

2. The control system according to claim 1, further comprising:
air-fuel ratio determination means for determining an air-fuel ratio of air-fuel mixture of the internal combustion engine,
wherein the ignition timing control means is configured to perform the advance control in a period, in which air-fuel mixture is determined to be richer than a predetermined condition in accordance with the air-fuel ratio determined by the air-fuel ratio determination means, after the internal combustion engine begins the cold startup, and
the quick-warming control means is configured to start the quick-warming control in response to the air-fuel mixture determined to be leaner than the predetermined condition.

3. The control system according to claim 1, further comprising:
engine speed determination means for determining revolution speed of the internal combustion engine,
wherein the ignition timing control means is configured to perform the advance control in a period between beginning of the cold startup of the internal combustion engine and a time point where the revolution speed determined by the engine speed determination means increases to be equal to a target revolution speed, and
wherein the quick-warming control means is configured to start the quick-warming control in response to the revolution speed becoming greater than the target revolution speed.

4. The control system according to claim 1, further comprising:
catalyst temperature determination means for obtaining catalyst temperature information relating to the temperature of the catalyst,
wherein the ignition timing control means is configured to perform the advance control in a period between beginning of the cold startup of the internal combustion engine and a time point where the temperature of the catalyst is determined to be increasing to be predetermined temperature in accordance with the catalyst temperature information determined by the catalyst temperature determination means, and
the quick-warming control means is configured to start the quick-warming control in response to the catalyst temperature becoming greater than the value corresponding to the predetermined temperature.

5. The control system according to claim 1, further comprising:
exhaust heat determination means for determining a cumulative amount of exhaust heat emitted from the internal combustion engine,
wherein the ignition timing control means is configured to perform the advance control in a period between beginning of the cold startup of the internal combustion engine and a time point where the cumulative amount is determined to be increasing to be a threshold, and
the quick-warming control means is configured to start the quick-warming control in response to the cumulative amount becoming greater than the threshold.

6. The control system according to claim 1, further comprising:
air-fuel ratio determination means for determining an air-fuel ratio of the internal combustion engine,
wherein the ignition timing control means manipulates the ignition timing according to the air-fuel ratio determined by the air-fuel ratio determination means when performing the advance control.

7. The control system according to claim 1, further comprising:
EGR quantity determination means for determining a quantity of exhaust gas recirculation in the internal combustion engine,
wherein the ignition timing control means manipulates the ignition timing according to the quantity determined by the EGR quantity determination means when performing the advance control.

8. The control system according to claim 1, wherein the ignition timing control means advances the ignition timing within a range of an optimal ignition timing when performing the advance control.

9. The control system according to claim 1,
wherein the quick-warming control means retards the ignition timing when performing the quick-warming control, and
the quick-warming control means controls the air-fuel ratio when performing the quick-warming control such that air-fuel mixture becomes leaner than that in the advance control.

10. The control system according to claim 1, wherein the catalyst is a hydrocarbon adsorption catalyst configured to adsorb hydrocarbon components in exhaust gas of the internal combustion engine.

11. The control system according to claim 10,
wherein the hydrocarbon adsorption catalyst is in the shape of a hexagonal cell, and
the hexagonal cell has a base material having a surface being coated with both a hydrocarbon adsorption layer and a catalyst component layer.

12. The control system according to claim 11, wherein the hydrocarbon adsorption catalyst is in the shape of a hexagonal cell and configured to have a total weight of both the base material and the hydrocarbon adsorption layer each being less than that being in the shape of a square cell per unit surface area.

13. A method for controlling an internal combustion engine having an exhaust passage provided with a catalyst to purify exhaust gas, the method comprising:
performing cold startup of the internal combustion engine;
performing an advance control to advance an ignition timing further than an idling-ignition timing at the time of an idling operation after the beginning of the cold startup; and
performing a quick-warming control to accelerate warming up of the catalyst when a predetermined condition to terminate the advance control is satisfied.

14. The method according to claim 13, further comprising:
determining an air-fuel ratio of air-fuel mixture of the internal combustion engine,
wherein the predetermined condition is satisfied when air-fuel mixture is determined to be leaner than a predetermined richness in accordance with the air-fuel ratio.

15. The method according to claim 13, further comprising:
determining revolution speed of the internal combustion engine,
wherein the predetermined condition is satisfied when the revolution speed becomes greater than the target revolution speed.

16. The method according to claim 13, further comprising:
obtaining catalyst temperature information relating to the temperature of the catalyst,
wherein the predetermined condition is satisfied when the temperature of the catalyst is determined to be greater than predetermined temperature in accordance with the catalyst temperature information.

17. The method according to claim 13, further comprising:
determining a cumulative amount of exhaust heat emitted from the internal combustion engine,
wherein the predetermined condition is satisfied when the cumulative amount becomes greater than the threshold.

18. The method according to claim 13 further comprising:
determining an air-fuel ratio of the internal combustion engine,
wherein the performing of the advance control includes:
manipulating the ignition timing according to the air-fuel ratio.

19. The method according to claim 13, further comprising:
determining a quantity of exhaust gas recirculation in the internal combustion engine,
wherein the performing of the advance control includes:
manipulating the ignition timing according to the quantity of exhaust gas recirculation.

20. The method according to claim 13,
wherein the performing of the advance control includes:
advancing the ignition timing within a range of an optimal ignition timing.

21. The method according to claim 13,
wherein the performing of the quick-warming control includes:
retarding the ignition timing; and
controlling the air-fuel ratio such that air-fuel mixture becomes leaner than air-fuel mixture in the performing of the advance control.
